(19) United States
(12) Patent Application Publication
(10) Pub. No.: US 2008/0306879 A1
(43) Pub. Date: Dec. 11, 2008

(54) SYSTEM AND METHOD FOR CREATING A PRIMARY AND SECONDARY MARKET IN WHOLE AND BIFURCATED LAND TENANT IN COMMON REAL PROPERTY OWNERSHIP INTERESTS

(76) Inventor: Alan W. Legatz, Naples, FL (US)

Correspondence Address: DON J. PELTO;Sheppard, Mullin, Richter & Hampton LLP, 1300 I STREET, NW, 11TH FLOOR EAST, WASHINGTON, DC, 20005, US

(21) Appl. No.: 11/758,737

(22) Filed: Jun. 6, 2007

(51) Int. Cl. G06Q 40/00

(52) U.S. Cl. 705/36 R

(57) ABSTRACT

The present invention relates to systems, methods, and articles of manufacture for the exchange of tenant in common real property ownership interests, either by physical or electronic exchange. The present invention also relates to methods for creating a secondary market for the buying and selling of tenant in common real property ownership interests. Additionally, the present invention relates to the creation of a primary and secondary market in bifurcated land TIC agreements.

### FIELD OF THE INVENTION

The present invention relates to the monetization of land using tenant in common real property ownership interests. Specifically, the present invention relates to creating a primary market in tenant in common (TIC) real property ownership interests using a bifurcated land TIC agreement. Additionally, the present invention relates to creating a secondary market in deeded TIC real property ownership interests. These interests may comprise a traditional “slice of a whole” TIC investment comprising vacant land, surface and subsurface mineral rights, and improved land. Alternatively, these interests may be unimproved land from which all land improvement assets have been legally bifurcated. The market may be a traditional physical market in a specific location. The market may also be an electronic one, comprising one or more computer programs and an electronic data network.

### BACKGROUND OF THE INVENTION

Real estate is attractive as an investment because traditionally it has tended to appreciate over the long term. However, one drawback to land as an investment, prior to the present invention, is that land has been a somewhat illiquid investment. Therefore, land is generally purchased for a specific use. For example, land may be purchased for building structures upon it, for residential, commercial, or industrial uses. Examples of such structures are single-family homes or high-density housing: offices or retail stores; foundries, factories, mills, mines, and oil drilling facilities. Land may be purchased for agricultural purposes, such as farming, ranching, timber, or aquaculture. Alternatively, land may be purchased with the intent of developing for recreational purposes; e.g., for resorts, ski resorts, casinos, race tracks, camps, amusement parks, golf courses, tennis courts, and so on.

Therefore, for instance, if one buys a plot of land and builds an apartment complex on it, the cost of the land is merely part of the cost of the commercial apartment project. The land, and the cost of this property, has been committed to that commercial dwelling purpose.

This type of investment creates two separate liquidity problems. The first is that the buyer in the apartment building project will have a large amount of capital invested in the price of the land. Normally, he cannot easily recover the cost of the land unless he sells the entire project. The second problem is that other buyers cannot invest in the land, because it has been committed for use in that particular project. There is currently no mechanism in place to invest in the land separately from the land improvements and still have a liquid investment.

Traditionally, buyers have attempted to recover capital investment in real estate projects using a leaseback arrangement. In a leaseback arrangement, the primary buyer buys land and develops it for a use he needs. Once the building project is finished, the primary buyer sells the property to a secondary buyer, and then leases the property back. This allows the primary buyer to regain the capital invested, and allows the land to be used for its intended purpose. Additionally, this allows the secondary buyer to invest in a project that has already been completed and already has a stable tenant. This type of arrangement is very common in the area of “big box” retail, in which a retailer develops the project, sells it to a secondary buyer, and then leases the building back from the secondary buyer to run the retail business.

In addition to allowing the primary buyer to recover capital, these leaseback arrangements may also provide certain tax benefits. Because the lease is now considered a business expense for the primary buyer, it is generally tax deductible, subject to the laws and regulations applicable in that locale. However, these leaseback arrangements tend to be an all-or-nothing type of investment. In other words, the secondary buyer must be able to buy the entire property, as opposed to a fractional interest in it. Also, in some cases, the IRS disallows the rent deduction because they deem the leaseback to be long-term financing disguised as a lease.

Another option for making land liquid is a tenancy in common (TIC) agreement. In this arrangement, multiple buyers buy TIC ownership interests in a single real property. This allows buyers to buy a fractional interest in real estate and then receive a pro rata share of any income derived from it. TIC buyers may also be entitled to a pro rata share of property depreciation, maintenance costs, or other expenses for tax purposes. TIC agreements can pertain to the actual land, or to other assets related to the land such as mineral rights or structures built upon the land.

In the past, however, TIC investments also have been somewhat illiquid for several reasons. All TIC agreements require a buyer to sign the TIC agreement upon acquisition. However, in the past, some TIC agreements required right of first refusal, or at least first approval, by the remaining TIC owners when one owner wants to sell his interest. This means that if a buyer wants to sell his interest in the TIC, he has to first offer it to the other TIC owners. Then, even if the other owners decline to purchase the interest, the new buyer has to be approved by a unanimous (or sometimes majority) vote of the remaining TIC owners.

A second hindrance to the liquidity of TIC investments has been the Security and Exchange Commission's (SEC) classification of these investments as securities, subject to SEC regulations. Because the land improvement assets often require management, the success of the investment is largely dependent on the “efforts of others.” This tends to lead the SEC to classify an investment as a security. Regulation by the SEC increases the complexity of transacting in this type of investment. This complexity has traditionally deterred greater offerings of, and investment in, TICs by the public.

Thirdly, there is not an organized and accurate secondary market in TIC investments. The current market in TIC investments is fractionalized, with TIC investments generally only being sold by each individual promoter and a handful of agents. Buyers are wary of fractionalized markets as there is no ready source for unbiased information upon which to base investment decisions and no ready market for subsequent sales. Additionally, due to a history of some degree of impropriety in the TIC industry, buyers tend to think of TIC investments as an investment “scheme” rather than a solid investment.

The present invention addresses all of these concerns by creating a primary and secondary market in TIC real property ownership interests in which the land (including surface and subsurface mineral rights) has been legally bifurcated from any land improvements. Additionally, the present invention creates an organized and centralized exchange in investments in slice of a whole TIC real property ownership interests. The present system therefore provides several avenues for investment: a primary market in bifurcated land TIC investments, and an organized secondary market in bifurcated land TIC investments, and an organized secondary market in a slice of a whole TIC investments.

### SUMMARY OF THE INVENTION

The present invention relates to a system comprising an exchange for tenant in common real property ownership interests. In one embodiment, the tenant in common real property ownership interests comprise fractional ownership in a slice of a whole tenant in common property. In another embodiment, the tenant in common real property ownership interests comprise fractional ownership in a bifurcated land tenant in common property. In another embodiment the slice of a whole tenant in common property comprises one or more selected from the group consisting of vacant land, surface natural resource rights, subsurface natural resource rights, and land improvement assets.

In yet another embodiment, a bifurcated land tenant in common property comprises vacant land, surface natural resource rights, and subsurface natural resource rights that have been legally bifurcated from all land improvement assets. The surface natural resources rights may comprise one or more selected from the group consisting of water rights, mineral rights, and timber rights. The subsurface resources rights may comprise one or more selected from the group consisting of water rights, mineral rights, and fossil fuel rights. Finally, the land improvement assets may comprise one or more selected from the group consisting of structures built upon said land, agricultural assets, and recreational assets.

In one embodiment, the structures comprise one or more from the group consisting of single-family homes, high-density housing, office buildings, retail stores, factories, mills, foundries, mines, and oil drilling facilities. The agricultural assets may comprise one or more from the group consisting of farms, ranches, slaughterhouses, and aquaculture facilities. In still another embodiment, the recreational assets comprise one or more from the group consisting of golf courses, tennis courts, amusement parks, private clubs, resorts, ski resorts, camps, hunting areas, race tracks and casinos. Further, surface natural resources rights comprise one or more selected from the group consisting of water rights, mineral rights, and timber rights.

Additionally, the subsurface resources rights comprise one or more selected from the group consisting of water rights, mineral rights, and fossil fuel rights. In one embodiment, the land improvement assets comprise one or more selected from the group consisting of structures built upon said land, agricultural assets, and recreational assets. In another embodiment, the structures comprise one or more from the group consisting of single-family homes, high-density housing, office buildings, retail stores, factories, mills, foundries, mines, and oil drilling facilities. Also, the agricultural assets comprise one or more from the group consisting of farms, ranches, slaughterhouses, and aquaculture facilities. Finally, the recreational assets comprise one or more from the group consisting of golf courses, tennis courts, amusement parks, private clubs, resorts, ski resorts, camps, hunting areas, racetracks, and casinos.

In one embodiment, the exchange comprises a physical exchange in a specified location. In another embodiment, the exchange comprises an electronic exchange that exists on an electronic data network. In yet another embodiment, the exchange utilizes one or more physical exchanges in one or more physical locations and one or more electronic exchanges that exist over an electronic data network. In another embodiment the seller may use a qualified intermediary to facilitate the transaction.

In one embodiment, the present invention is a method comprising the steps of receiving a request to sell a tenant in common real property interest from a seller, providing said sale price to one or more users, receiving one or more bids for said tenant in common real property ownership interests from one or more buyers, providing said bid prices to one or more users; and deciding whether to accept one or more bids from said one or more buyers. Further, the sell request comprises one or more selected from the group consisting of the seller, the price, number of interests available, and location of the property. In one embodiment, the sell request is received by an auctioneer in an open outcry type of auction. In yet another embodiment, the sell request is received and stored by a program stored on one or more computers.

In one embodiment, these computers are linked via an electronic data network. In another embodiment, the electronic data network comprises one or more selected from the group consisting of the internet, an intranet, a token ring network, a wireless network, or a blue tooth network. The sale price may be provided to one or more users in an open outcry type of auction. It may also be provided to one or more users using a graphical user interface on one or more computers linked via an electronic data network. The electronic data network may comprise one or more selected from the group consisting of the internet, an intranet, a token ring network, a wireless network, or a blue tooth network.

In one embodiment, the bids are received by an auctioneer in an open outcry type of auction. In another embodiment, the bids are received and stored by a program on one or more computers. In yet another embodiment, the one or more computers are linked via an electronic data network. In still another embodiment, the electronic data network comprises one or more selected from the group consisting of the internet, an intranet, a token ring network, a wireless network, or a blue tooth network. In still another embodiment, the bids are provided to one or more users via a graphical user interface on one or more computers linked via an electronic data network. Finally, the electronic data network comprises one or more selected from the group consisting of the internet, an intranet, a token ring network, a wireless network, or a blue tooth network, in another embodiment, the seller may use a qualified intermediary to facilitate the transaction.

In still another embodiment, there is a system comprising a memory device storing a program, a processor in communication with said memory device, said processor operable with said program to receive a request to sell a tenant in common real property interest from a seller, provide said sale price to one or more users, receive one or more bids for said tenant in common real property ownership interests from one or more buyers, provide said bid prices to one or more users and decide whether to accept one or more bids from said one or more buyers. Also, the processor is further operable to query a database comprising bids from one or more buyers, approve all bids that are higher than the price requested in the sell request and that do not exceed the number of interests available in said sell request, and deny all bids that are below the price requested in the sell request or that exceed the number of interests available in said sell request. Finally, the processor is further operable to provide a list of available sell requests and buy bids from one or more users.

In one embodiment, the list of sell requests and buy bids is provided via a graphical user interface on one or more computers linked via an electronic data network. And, the processor is further operable to update a list of available sell requests and buy bids in real time. In another embodiment, the processor is further operable to remove a sell request from a list of available sell requests when the number of interests in said sell request reaches zero.

In one embodiment, the tenant in common real property ownership interests comprise fractional ownership in a slice of a whole tenant in common property. In another embodiment, the tenant in common real property ownership interests comprise fractional ownership in a bifurcated land tenant in common property. In yet another embodiment, the slice of a whole tenant in common property comprises one or more selected from the group consisting of vacant land, surface natural resource rights, subsurface natural resource rights, and land improvement assets. In one embodiment, the bifurcated land tenant in common property comprises vacant land, surface natural resource rights, and subsurface natural resource rights that have been legally bifurcated from all land improvement assets.

In one embodiment, the surface natural resources rights comprise one or more selected from the group consisting of water rights, mineral rights, and timber rights. In another embodiment, the subsurface resources rights comprise one or more selected from the group consisting of water rights, mineral rights, and fossil fuel rights. In still another embodiment, the land improvement assets comprise one or more selected from the group consisting of structures built upon said land, agricultural assets, and recreational assets. In another embodiment, the structures comprise one or more from the group consisting of single-family homes, high-density housing, office buildings, retail stores, factories, mills, foundries, mines, and oil drilling facilities.

In still another embodiment, the agricultural assets comprise one or more from the group consisting of farms, ranches, slaughterhouses, and aquaculture facilities. In vet another embodiment, the recreational assets comprise one or more from the group consisting of golf courses, tennis courts, amusement parks, private clubs, resorts, ski resorts, camps, hunting areas, racetracks, and casinos. In another embodiment, the surface natural resources rights comprise one or more selected from the group consisting of water rights, mineral rights, and timber rights. In still another embodiment, the subsurface resources rights comprise one or more selected from the group consisting of water rights, mineral rights, and fossil fuel rights. Additionally, the land improvement assets comprise one or more selected from the group consisting of structures built upon said land, agricultural assets, and recreational assets. In another embodiment, the structures comprise one or more from the group consisting of single-family homes, high-density housing, office buildings, retail stores, factories, mills, foundries, mines, and oil drilling facilities. Moreover, the agricultural assets comprise one or more from the group consisting of farms, ranches, slaughterhouses, and aquaculture facilities. Also, the recreational assets comprise one or more from the group consisting of golf courses, tennis courts, amusement parks, private clubs, resorts, ski resorts, camps, hunting areas, race tracks and casinos. In another embodiment, the seller may use a qualified intermediary to facilitate the transaction.

In yet another embodiment, the present invention is an article of manufacture comprising a computer readable storage medium comprising instructions, said instructions comprising instructions for receiving a request to sell a tenant in common real property interest from a seller, providing said sale price to one or more users, receiving one or more bids for said tenant in common real property ownership interests from one or more buyers, providing said bid prices to one or more users, and deciding whether to accept one or more bids from said one or more buyers. Additionally, it is an article of manufacture in which the processor is further operable to querying a database comprising bids from one or more buyers, approving all bids that are higher than he price requested in the sell request and that do not exceed the number of interests available in said sell request, and denying all bids that are below the price requested in the sell request or that exceed the number of interests available in said sell request. Moreover, the processor is further operable to provide a list of available sell requests and buy bids from one or more users. Also, the list of sell requests and buy bids is provided via a graphical user interface on one or more computers linked via an electronic data network. In one embodiment, the processor is further operable to update a list of available sell requests and buy bids in real time. In another embodiment, the processor is further operable to remove a sell request from a list of available sell requests when the number of interests in said sell request reaches zero.

In one embodiment, the tenant in common real property ownership interests comprise fractional ownership in a slice of a whole tenant in common property. In another embodiment, the tenant in common real property ownership interests comprise fractional ownership in a bifurcated land tenant in common property. In still another embodiment, a slice of a whole tenant in common property comprises one or more selected from the group consisting of vacant land, surface natural resource rights, subsurface natural resource rights, and land improvement assets. In yet another embodiment, a bifurcated land tenant in common property comprises vacant land, surface natural resource rights, and subsurface natural resource rights that have been legally bifurcated from all land improvement assets.

In one embodiment, the surface natural resources rights comprise one or more selected from the group consisting of water rights, mineral rights, and timber rights. In another embodiment, the subsurface resources rights comprise one or more selected from the group consisting of water rights, mineral rights, and fossil fuel rights. Additionally, the land improvement assets comprise one or more selected from the group consisting of structures built upon said land, agricultural assets, and recreational assets.

In still another embodiment, the structures comprise one or more from the group consisting of single-family homes, high-density housing, office buildings, retail stores, factories, mills, foundries, mines, and oil drilling facilities. Also, the agricultural assets comprise one or more from the group consisting of farms, ranches, slaughterhouses, and aquaculture facilities. Moreover, the recreational assets comprise one or more from the group consisting of golf courses, tennis courts, amusement parks, private clubs, resorts, ski resorts, camps, hunting areas, racetracks, and casinos. Additionally, the surface natural resources rights comprise one or more selected from the group consisting of water rights, mineral rights, and timber rights.

In another embodiment, the subsurface resources rights comprise one or more selected from the group consisting of water rights, mineral rights, and fossil fuel rights. In one embodiment, the land improvement assets comprise one or more selected from the group consisting of structures built upon said land, agricultural assets, and recreational assets. In still another embodiment, the structures comprise one or more from the group consisting of single-family homes, high-density housing, office buildings, retail stores, factories, mills, foundries, mines, and oil drilling facilities. In yet another embodiment, the agricultural assets comprise one or more from the group consisting of farms, ranches, slaughterhouses, and aquaculture facilities. Finally, in another embodiment, the recreational assets comprise one or more from the group consisting of golf courses, tennis courts, amusement parks, private clubs, resorts, ski resorts, camps, hunting areas, racetracks, and casinos. In another embodiment, the seller may use a qualified intermediary to facilitate the transaction.

### BRIEF DESCRIPTION OF THE DRAWING

FIG. 1 is a flow chart showing the exemplary step of offering a BaLTIC investment for the first time using the primary side of the market.

FIG. 2 is a flow chart showing the exemplary steps involved when a buyer makes a bid on a BaLTIC investment using the secondary side of the market.

FIG. 3 is a flow chart showing what happens when a buyer and a seller have a meeting of the minds and there is a sale or trade of a BaLTIC investment over the CTTS.

FIG. 4 is a flow chart showing exemplary steps involved in a seller making a TIC investment available over a centralized TIC trading system (CTTS).

FIG. 5 is a flow chart showing exemplary steps involved in a buyer making an offer for a TIC investment over a CTTS.

FIG. 6 is a flow chart showing exemplary steps involved when a buyer and a seller have a “meeting of the minds” and a transaction is successful on the CTTS.

FIG. 7 shows various components of a traditional “brick and mortar” type of exchange using an open outcry type of auction system.

### DETAILED DESCRIPTION OF THE INVENTION

It is understood that the present invention is not limited to the particular methodologies, protocols, systems and methods, etc., described herein, as these may vary. It is also to he understood that the terminology used herein is used for describing particular embodiments only, and is not intended to limit the scope of the present invention. It must be noted that as used herein and in the appended claims, the singular forms “a,” an,” and “the” include the plural reference unless the context clearly dictates otherwise. For instance, a reference to a sensor refers to one or more sensors and a reference to “a system” is a reference to one or more systems and includes equivalents thereof known to those skilled in the art and so forth.

Unless defined otherwise, all technical and scientific terns used herein have the same meanings as commonly understood by one of ordinary skill in the art to which this invention belongs. Specific methods, devices, systems, and materials are described, although any methods and materials similar or equivalent to those described herein can be used in the practice or testing of the present invention. The definitions that follow are not meant to be limiting in nature, but serve to provide a clearer understanding of certain aspects of the present invention.

The term “investment,” as used herein, relates to the choice made by the buyer to commit money, currency or other funds in transactions including those typically utilized in trading real property or the whole or fractional interests therein, or trading of the rights associated with such property or interests, e.g. mineral rights. For the purposes of the present invention, the term “buyer” is used throughout where traditionally one might understand “investor”; i.e., the buyer is the party to the transaction who selects the ownership interests offered for sale, and commits funds for their purchase or for investment in them.

As used herein, the term “outcry auction” refers to any auction where the auction is conducted orally for people to hear. This type of auction also refers to what is traditionally used in stock exchanges and commodity exchanges, where trading occurs on a trading floor and traders may enter verbal bids and offers simultaneously. Transactions may take place simultaneously at different places on the trading floor.

As used herein and for the purposes of the present invention, the term “trading floor” refers to the area in a physical exchange where trading of interests takes place. As such, a “trading floor” is a trading venue. This expression often refers to stock exchanges and, more precisely, to the open outcry auction institution where traders or brokers meet in order to buy and sell investments, commodities, real estate interests, etc. The expression “trading floor” may also used to refer to the trading room or dealing room; i.e., the office space where market activities are concentrated in real estate brokerage houses, or other markets. A “trading floor” may also be referred to as a trading pit or ring, or market or exchange floor.

As used herein, the term “put option,” also known as a “put,” refers to a financial contract between two parties, the buyer and the writer of the option (a seller). The put allows the buyer the right but not the obligation to sell the underlying investment to the writer of the option for a certain time for a certain price (the “strike price”). The writer has the obligation to purchase the underlying asset at the strike price, if the buyer exercises the option.

As used herein, the term “call option,” also known as a “call,” refers to a financial contract between two parties, the buyer and the seller, of this type of option. The buyer of the option has the right but not the obligation to buy an agreed quantity of the underlying investment from the seller by a certain date (the expiration date) for a certain price (the strike price). The seller (or “writer”) is obligated to sell the investment should the buyer so decide.

The term “slice of a whole TIC investment” as used herein is defined as interests in a TIC that are a fractional interest of a real estate project including the land and all improvements. Investors are merely buying a slice of the total investment in the project. The term “bifurcated land TIC investment” or “BaLTIC” refers to a TIC investment in which the land has been legally bifurcated from all land improvement assets. As a result, this is a pure land investment, equivalent to an investment in undeveloped land.

The methods and systems of the present invention may provide real-time market data and communication links to and/or between buyers and sellers. The invention makes possible the monitoring of the value of real property of various types, the receiving of real estate data, the entering of executing of orders, and the storage of the orders. In addition, users of the methods and systems of the present invention may automatically receive confirmations of transaction executions, access static data from a financial information database, and analyze real estate for potential investment using such data and real-time prices.

The present invention creates an organized and centralized market for slice of a whole TIC real property ownership interests. In one embodiment, this system may require that participating TIC agreements be structured such that new buyers do not require the approval of all existing investors. Buyers merely have to complete the existing TIC agreement before taking possession of any TIC shares purchased. While this may have been a cause for owner concern in the past, this is a much more tenable situation when there is a relevant secondary market.

As the liquidity of the market increases, the need to approve all investors in a TIC agreement decreases. For similar reasons, the wariness of investors to enter a TIC agreement diminishes as well. Investors displeased with new or existing investors or investments can merely sell or trade their interests and move on. Moreover, investors can easily assess value and stability for various TIC properties because information and analysis is available through a centralized trading system. A liquid and transparent market may be created similar to the NYSE and NASDAQ for stocks, bonds, and commodities.

This creates a secondary market in whole slice of TIC investments; however, the SEC treats traditional TIC investments as securities. This makes current TIC investments subject to SEC regulations and increases the complexity for buyers and sellers alike, even in an organized secondary marketplace. As a result, the first prong of the present invention provides for the bifurcation of the unimproved land and the surface and subsurface mineral rights (“bifurcated land”) from land improvement assets. This allows fractional interests to be offered in the land alone. These bifurcated land TICs (BaLTICs) should not be considered a security by the SEC, because they are sold separately from the land improvement assets such as buildings, parking structures, oil wells, and the like, that required the “efforts of others”.

When the land is legally bifurcated from the land improvement assets, this type of investment should be deemed a non-security by the SEC. There are also additional benefits related to their taxation. Under Internal Revenue Code §1031, if these BaLTIC interests are traded for “like-kind” interests in other BaLTIC real property ownership interests of the same overall value, there is no recognition of gain or loss by the taxpayer and thus no tax on the transaction. Therefore, investors are able to trade like-kind property for the purposes of diversification, speculation, etc., without paying taxes on each transaction.

Additionally, under Rev. Rul. 2002-22, 2002-19 I.R.B. 849, as long as these TIC agreements do not have more than 35 owners, the TICs will not be taxed at the entity level. In other words, the IRS gives these agreements “pass through” taxation in which only the individual owners are taxed on capital gains. This is in contrast to entity taxation, like in a C Corporation, where the corporation, or entity, is taxed on profits and gains, and then the shareholders are taxed on dividends and gains as well, creating a double taxation problem. In addition, Rev. Rul. 2002-22, 2002-19 I.R.B. 849 only applies to TICS that involve a business interest. However, because the land has been legally bifurcated from all land improvement assets in BaLTICs, there is no business interest. This should make the 35-investor limitation of Rev. Rul. 2002-22 inapplicable to BaLTICs.

The economic market force that drives the bifurcated land TIC market is that it naturally separates the higher risk of investing in land improvements from the lower risk of owning the underlying land. This separation of risk is not available in the traditional “slice of the whole” TIC investments that include land improvements as well as the underling land. This more natural separation of investment risk allows security investors that own or want to build the more risky land improvements to receive a higher yield potential because they have leased the land for the building improvements from the bifurcated land TIC investors. These land TIC investors will receive a more conservative and secure return from the land lease payments they receive on their deeded real estate TIC investment.

This lower investment capital cost for land is economically available because the individual land TIC owners can trade their TIC deeds as tax-free real estate under Section 1031 of the Internal Revenue Code at any time in the secondary market. This is so even if the TIC land they own is committed to a long term lease to the land improvement owner(s) or the surface or subsurface mineral deposit exploitation firm(s). For example, one can monetize the land under any structure by creating a bifurcated land TIC where the land TIC owners receive an annual cash return, for example, 6-7.5%, and a modest appreciation factor, for example 3%, if the building improvement owners wish to exercise their option to marry their improvements back to the land at some future date.

However, because this bifurcation step represents new investment technology, it is necessary to create both a primary and a secondary market in BaLTIC real property interests. The primary market is that part of the market that deals with issuing new investments. The present invention is intended to create a primary real estate market similar to that of an initial product offering (IPO) in a securities market.

When a new BaLTIC becomes available, a large investor or an investment bank may underwrite the owner of the BaLTIC. In this case, the underwriter agrees to sell the interests in the BaLTIC in return for a real estate commission, or buys all interests in a BaLTIC at below market value in return for assuming the risk. Alternatively, the BaLTIC may be sold directly to individual investors using the primary side of the real estate market created herein. In either case, the initial offering is made through the centralized market created herein. This market provides real estate investors with a central source for such primary investments.

In another embodiment, the present invention creates a secondary market in BaLTIC real property investments. This allows investors to freely trade interests in BaLTIC investments through a stable, centralized entity. Buyers may buy BaLTIC interests outright, or they may trade interests in various types of allowable like-kind transactions to allow the favorable tax treatment of IRC §1031. This allows market forces to establish a relevant market value for BaLTIC investments. It further provides a central source of information that can be used for various types of market analysis.

By creating a secondary market for TIC investments and a prima and secondary market for BaLTIC investments, the present invention adds capital and raises the value of the TIC market, and the commercial real estate market in general. Firstly, it creates a more stable, liquid market in the traditional or slice of a whole TIC market. This encourages more investors to participate in TIC investments, which, in turn, allows developers and investors in property to recover capital for use in future projects. Secondly, the present invention creates a new stable, liquid primary and secondary market in BaLTIC investments. This allows real estate investors a tax-free investment in land that was previously unavailable due to improvements on the land.

Finally, it allows developers to bifurcate land from land improvements to offer investors two distinct and very different types of investments. The land improvements, oil wells for instance, may be offered to those looking for high risk/high return investments. The unimproved land is more suited to those investors looking for a steady rate of return plus a steadily appreciating investment. All of these features increase the amount of capital available to the real estate developer, which, of course, promotes development.

The trading systems of the present invention may be organized as a physical exchange. This physical exchange could exist in a specified location or locations where buyers and sellers may trade TIC real property ownership interests, similar to the arrangement of traditional brick-and-mortar stock exchanges set up in most developed countries for trading company stocks and securities; e.g., the New York and American Stock Exchanges in the United States. Alternatively, the exchange may exist as an electronic stock exchange, providing an electronic method for buyers and sellers to enter their TIC or BaLTIC real property ownership interest trades, similar to the system provided by the electronic exchange prototype, the NASDAQ.

Finally, the exchange may comprise elements of both physical and electronic trading systems. The electronic stock exchange may exist over an electronic data network, such as the internet, and may be an online trading system. Online trading systems are known to those skilled in the art. For example, U.S. patent application Ser. No. 09/825,714 relates to a method for minors to make stock market transactions via the internet; and U.S. Pat. No. 6,773,350 relates to a virtual trading system game that is based on real data, but where no actual trades are made.

It is a further object of the present invention to provide methods and systems to enable individual buyers to select investments in slice of a whole TIC or in BaLTIC real property ownership interests. Yet another object is to encourage individual buyers to participate in the methods and systems of the present invention by allowing the individuals to realize the full gains and losses of their chosen investments, while at the same time providing incentives to invest, such as desirable transaction fees.

As will be appreciated by one of ordinary skill in the art, the electronic exchange embodiment of the present invention may be embodied as a method, a system, or a computer program product. Accordingly, the present invention may take the form of an entirely hardware embodiment an entirely software embodiment, or an embodiment combining software and hardware aspects. Furthermore, the present invention may take the form of a computer program product on a computer-readable storage medium having computer-readable program code means embodied in the storage medium. Any suitable computer readable storage medium may be utilized including hard disks, CD-ROMs, optical storage devices, or magnetic storage devices.

The present invention is described below with reference to a block diagram of methods, apparatus (i.e., systems), and computer program products according to an embodiment of the invention. It is understood that each block of the block diagram, and combinations of blocks in the block diagram, respectively, can be implemented by computer program instructions. These computer program instructions may be loaded onto a general-purpose computer, a special purpose computer, or other programmable data processing apparatus to produce a machine, such that the instructions that execute on the computer or other programmable data processing apparatus create means for implementing the functions specified in the diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the diagram block or blocks. The computer program instructions may also be loaded onto a computer or other programmable data processing apparatus to cause a series of operational steps to be performed on the computer or other programmable apparatus so as to produce a computer implemented process, such that the instructions which execute on the computer or other programmable apparatus provide steps for implementing the functions specified in the diagram block or blocks.

Accordingly, blocks of the diagram support combinations of ways for performing the specified functions, combinations of steps for performing the specified functions, and program instruction means for performing the specified functions. It is also understood that each block of the diagram, and combinations of blocks in the block diagram, can be implemented by special purpose hardware-based computer systems that perform the specified functions or steps, or combinations of special purpose hardware and computer instructions.

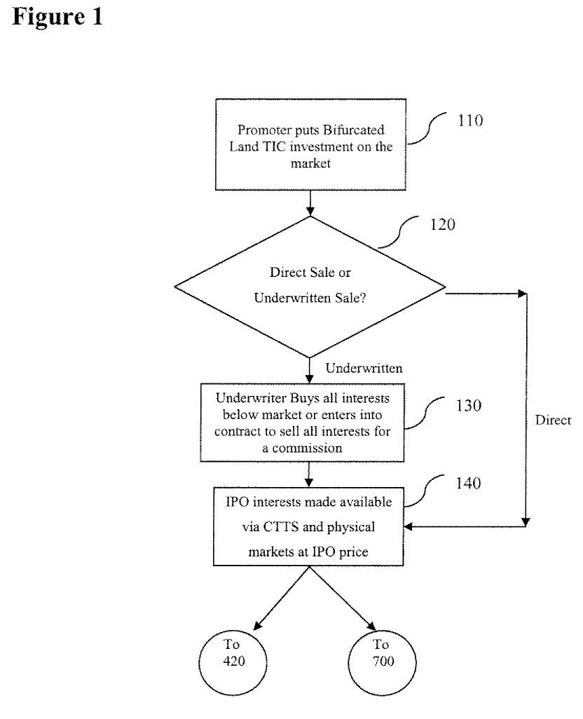

The present invention requires creating a primary market for BaLTICs. See FIG. 1. A primary market is one in which companies, or in this case BaLTIC promoters, make interests available to the public in a sale known as an Initial Public Offering (IPO). They may assume the risk themselves, and sell the interests directly to the public 140. Alternatively, the promoter may use an investment bank or other large investor (the “underwriter”to buy all of the interests and/or resell them to the public 130. The underwriter either buys the interests below market value or receives a commission, and specifically a real estate commission, on each sale for assuming the risk 130.

In either case, the present invention provides a centralized and organized primary market in which to make an Initial Product Offering (IPO) of real estate investments. Promoters can use the primary market portion of both the electronic and bricks and mortar type market to offer their interests to the public 140. Moreover, because this investment should not be classified as a security, many of the burdens associated with the sale or trade of securities are circumvented (e.g., filing a prospectus, quarterly and yearly earnings reports, etc.). This, unlike in a securities market, allows an IPO to be sold directly to the public and obviates the need for large investment banks and law firms to be involved to insure SEC compliance. However, promoters may still choose to use underwriters to minimize risk.

In addition to creating a primary market, the present invention also creates a secondary market in BaLTICs. This system works in the same manner as the secondary market created for traditional TICs mentioned below. The secondary market in BaLTICS will allow buyers to purchase BaLTICs for cash as they would a traditional TIC. Further, it will allow users to trade BaLTICs for other BaLTICS or other §1031 property directly, or using a qualified intermediary. Therefore constituting a like-kind tax-free transaction within the meaning of IRC §1031.

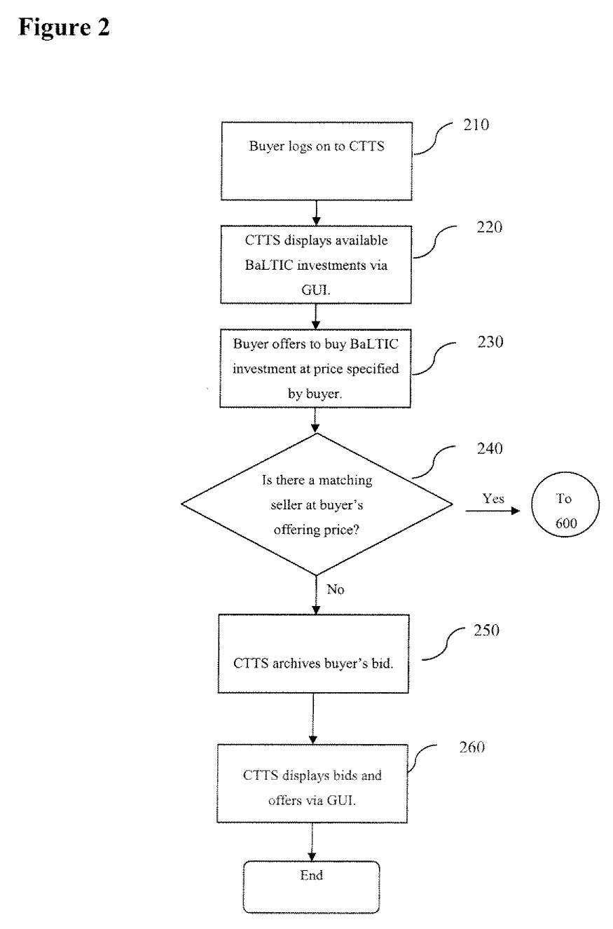

In FIG. 2, the buyer, who has also been previously registered and approved, logs on to the CTTS 210. The CTTS displays the available BaLTIC investment interests via a GUI or other suitable interface 220. The buyer then makes an offer to buy a specific BaLTIC investment at a specific price 230. The CTTS compares the bid made by the buyer to the offers made by all sellers of that particular investment 240. If there is no interest of that type offered at that price, the transaction fails. However, the CTTS creates a record of the bid 250.

The CTTS then makes information about the bid available to all buyers and sellers via a GUI or other suitable interface 260. This allows both buyers and sellers to see the “spread” on investments. The spread is the difference between the lowest price any seller is willing to sell a particular real estate investment for (in this case a BaLTIC investment) and the highest price any buyer is willing to pay for said real estate investment. If the buyer and seller are generally close to striking a deal, the spread will allow either the buyer to increase his bid, or the seller to decrease his offer, or both, until there is a “meeting of the minds”.

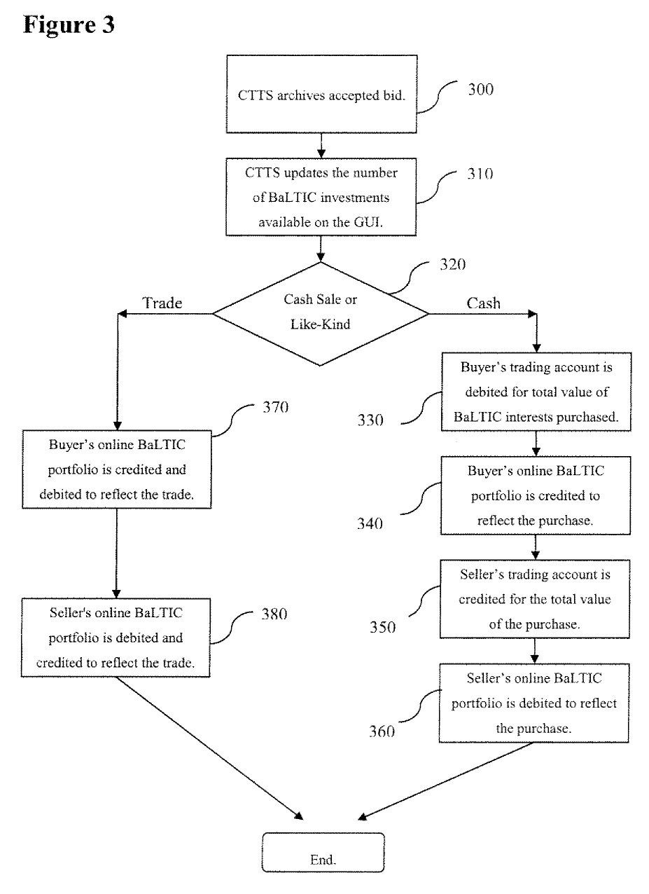

In FIG. 3, when there is a meeting of the minds, the CTTS accepts the buyer's bid 300. The CTTS then updates the number of interests of that particular investment on the GUI or other suitable interface 310. In one embodiment, if the remaining number of TIC interests becomes zero due to the present transaction, that investment is removed from the list for clarity. In an alternative embodiment, if interests of that particular investment are still available, previous sales are archived and may be made available to users via the GUI or other suitable interface to facilitate future sales.

In one embodiment, one of the requirements of registration is that the users provide bank account or credit card information to the central organizing body. To that end, when a sale is completed in 300 the CTTS automatically debits the funding source of the buyer for the total value of the BaLTIC investment(s) purchased 330. In one embodiment, the CTTS also charges the buyer a real estate transaction fee. The transaction fee may be a flat fee, a flat fee per interest, or may be a fee based on a percentage of the total sale. The CTTS then credits the buyer's online BaLTIC portfolio to reflect the number of interests purchased 340.

In one embodiment, the organizing body for the trading system may hold the funds for a number of days in order to ensure the availability of funds from the buyer. In another embodiment, the organizing body for the trading system may hold the funds for a number of days to take advantage of the “float” in lieu of or in addition to, transaction based fees. Float is defined as holding money for a certain period to use it in a way that is advantageous to the holder, such as to earn interest for example. Once the transaction has been completed with the buyer, the seller's bank and/or credit card account can be credited for the sale 350. In one embodiment, the CTTS also charges the seller a transaction fee. The transaction fee may be a flat fee, a flat fee per interest, or may be based on a percentage of the total sale. Finally, the seller's online BaLTIC portfolio is debited for the number of interests sold 360.

In another embodiment, the buyer and seller may wish to perform a like-kind trade of BaLTICs of equal value. Take, for example, a buyer who wishes to trade interests in BaLTIC A for interests of an equivalent value of interests in BaLTIC B. The buyer's BaLTIC portfolio is debited the appropriate number of interests of A and credited the appropriate number of interests of B 370. Of course, the offsetting transaction for the seller is that his account is credited interests of A and debited interests of B 380. This like-kind transaction may allow buyers and sellers to diversify their portfolio while availing themselves to favorable tax treatment under IRC §1031.

In another embodiment, the seller may use a qualified intermediary (“QI”) to facilitate a like-kind transaction rather than using an outright exchange. This allows the seller to sell the property, and replace it within 180 days, while still receiving like-kind treatment by the IRS. For instance, the seller enters into an agreement with a QI before sale of property A. The agreement assigns the sellers rights in property A to the qualified intermediary. At the closing of the property, the QI is listed as the seller. The QI takes the proceeds from the sale and places it in an escrow account. This is generally an insured money market account, or similarly liquid and secure investment. The seller must then declare intent to purchase property B within 45 days and close on property B within 180 days. At the closing the QI is listed as the buyer. The QI uses the funds in the escrow account to purchase property B. The QI then assigns his rights to the buyer after closing. The buyer then files form 8824 with the IRS and receives §1031 treatment for the deferred exchange.

In one embodiment of the current invention, TIC interests, slice of a whole or bifurcated, are bought and sold over an electronic network facilitated by a central controlling entity. The system is run by an organization that allows users to register to use the service. This registration may include gathering necessary information about buyers and sellers including, but not limited to, name, address, bank account information, credit card information, etc. The central organization may additionally require participants to meet certain credit worthiness requirements.

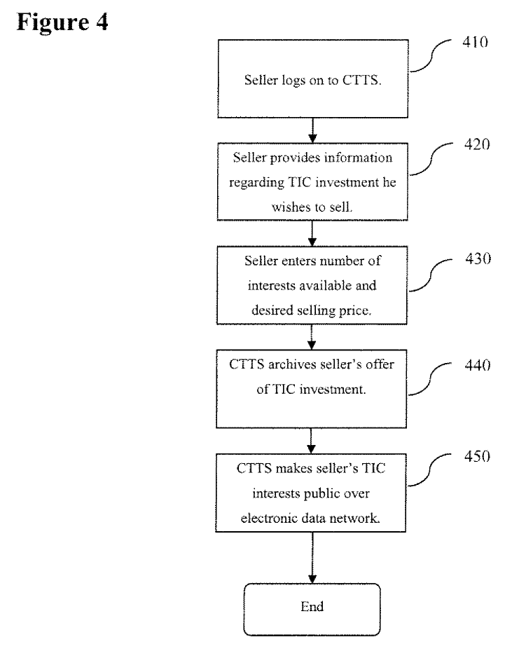

As shown in FIG. 4, the seller begins the process by making one or more interests in a TIC investment available over a centralized TIC trading system (CTTS). The seller, who has registered with the service, first logs onto the system 410. The seller then provides as much information about the property as he desires. At a minimum, the seller provides the information required by the sanctioning body. The information provided may be limited to the location of the property. However, the seller may include such additional information as the address of the property, whether the TIC investment is whole or bifurcated, the type of property, the type of rights for sale (e.g. real, mineral, fossil fuel, etc.), the name of the management company, etc. The seller may also wish to post further information such as previous financial performance, pictures of the property, the history of the property, and so on.

The seller then enters the number of interests for sale and the price per interest 420. The CTTS creates a record including the information provided by the seller, the number of interests for sale, and the price per interest 440. The CTTS then makes this information available to other registered users over an electronic network via a graphical user interface (GUI) or by other suitable means 450. The CTTS thus creates a list of TIC investments available for sale. This list is available to all registered users. In a specific embodiment, in order to make selection of desirable or appropriate properties more efficient for buyers, the list may be sortable by any number of parameters including, but not limited to, price, location, or number of interests available.

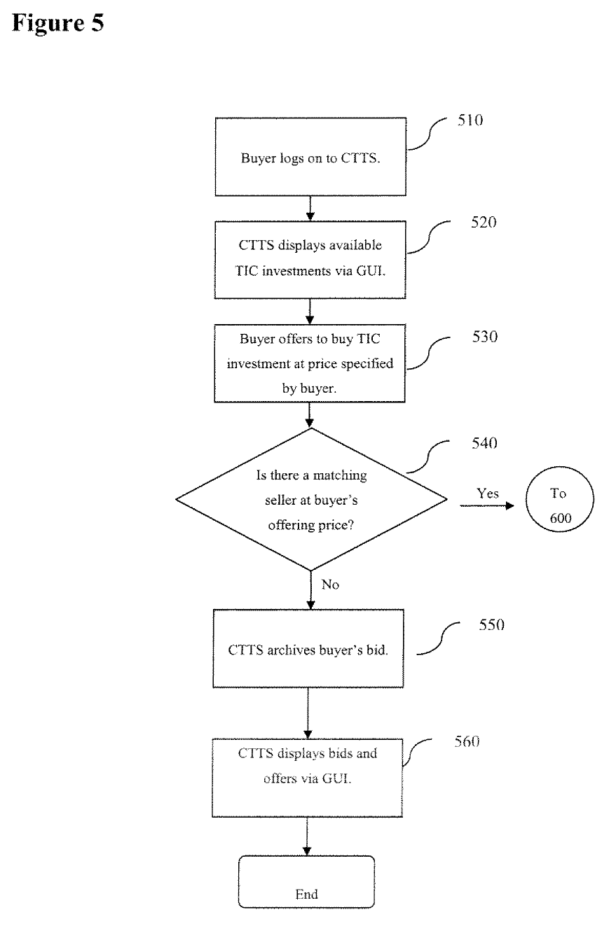

In FIG. 5, the buyer, who has also been previously registered and approved, logs on to the CTTS 510. The CTTS displays the available investment interests via a GUI or other suitable interface 520. The buyer then makes an offer to buy a specific TIC investment at a specific price 530. The CTTS compares the bid made by the buyer to the offers made by all sellers of that particular investment 540. If there is no interest of that type offered at that price, the transaction fails. However, the CTTS creates a record of the bid 550.

The CTTS then makes information about the bid available to all buyers and sellers via a GUI or other suitable interface 560. This allows both buyers and sellers to see the “spread” on investments. The spread is the difference between the lowest price at which any seller is willing to sell a particular real estate investment (in this case a TIC investment) and the highest price any buyer is willing to pay for said real estate investment. If the buyer and seller are generally close to striking a deal, the spread will allow either the buyer to increase his bid, or the seller to decrease his offer, or both, until there is a “meeting of the minds”.

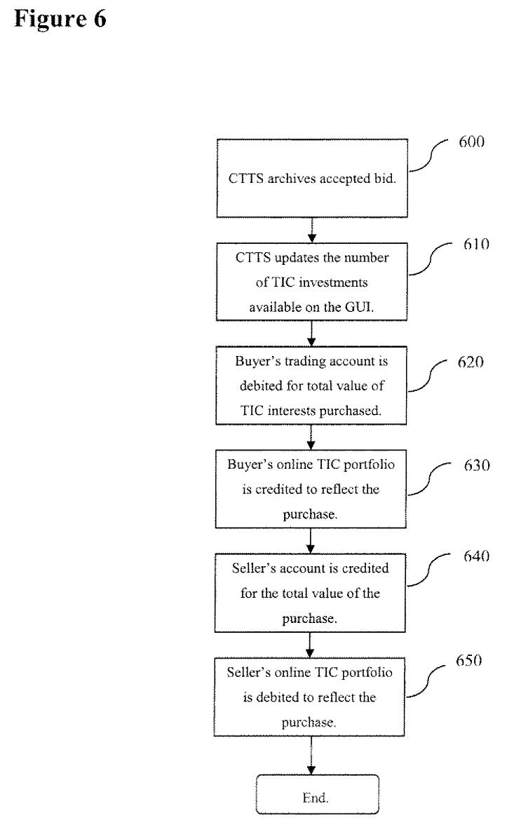

In FIG. 6, when there is a meeting of the minds, the CTTS accepts the buyer's bid 600. The CTTS then updates the number of interests of that particular investment on the GUI or other suitable interface 610 In one embodiment, if the remaining number of TIC interests becomes zero due to the present transaction, that investment is removed from the list for ease of use. In an alternative embodiment, if interests of that particular investment are still available, previous sales are archived and may be made available to users via the GUI or other suitable interface to facilitate research and future sales.

In one embodiment, one of the requirements of registration is that the users provide bank account or credit card information to the central organizing body. To that end, when a sale is completed in 600 the CTTS automatically debits the funding source of the buyer for the total value of the TIC investment(s) purchased 620. In one embodiment, the CTTS also charges the buyer a transaction fee. The transaction fee may be a flat fee, a flat fee per interest, or may be a fee based on a percentage of the total sale. The CTTS then credits the buyer's online TIC portfolio to reflect the number of interests purchased 630.

In one embodiment, the organizing body for the trading system may hold the funds for a number of days in order to ensure the availability of funds from the buyer. In another embodiment, the organizing body for the trading system may hold the funds for a number of days to take advantage of the “float” in lieu of or in addition to, transaction based fees. Float is defined as holding money for a certain period to use it in a way that is advantageous to the holder, such as to earn interest for example. Once the transaction has been completed with the buyer, the seller's bank and/or credit card account can be credited for the sale 640. In one embodiment, the CTTS also charges the seller a transaction fee. The transaction fee may be a flat fee, a flat fee per interest, or may be based on a percentage of the total sale. Finally, the seller's online TIC portfolio is debited for the number of interests sold 650.

In a further embodiment, the CTTS may provide additional services common to secondary markets to make the exchange more attractive to investors. The CTTS may provide analysis of certain types or locations of investments. This analysis may take the form of statistical or graphical analysis, or analysis by experts provided by the organizing body. The CTTS may additionally offer facilities for other services such as put and call options. There may also be a traditional futures type market in TIC investments.

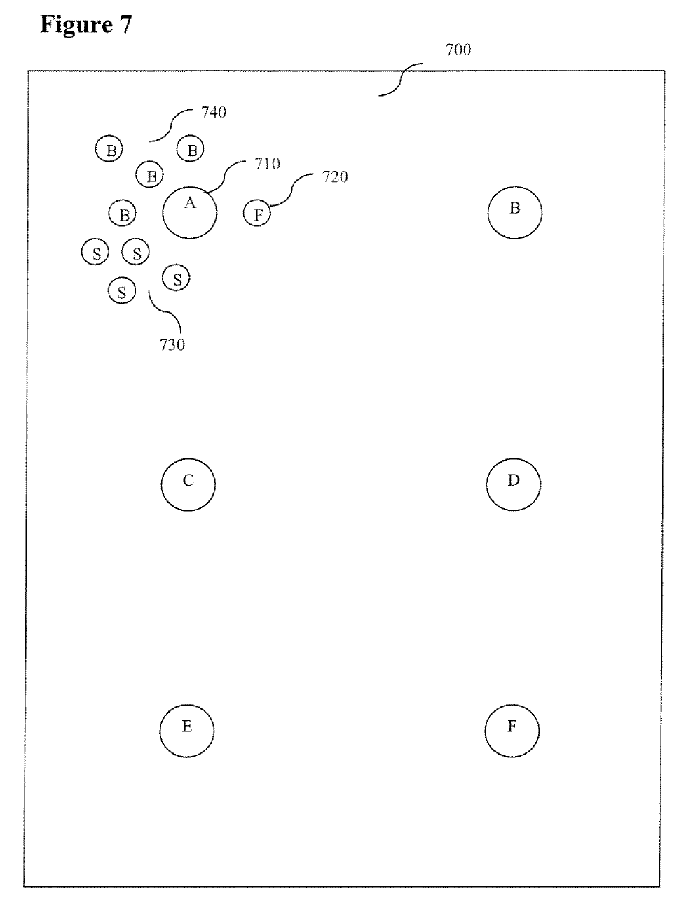

In a further embodiment, the exchange may take the form of a traditional brick and mortar type exchange, such as the floor of the New York Stock Exchange (NYSE). An example of this type of layout is shown in FIG. 7. In this embodiment, buyers and sellers gather in specified areas of the trading floor 700. For instance, buyers and sellers wishing to purchase or sell TIC investment interests in property “A” gather in the area of the floor designated for trading property “A” 710. This area may also be designated for more than one property or type of right. For instance, it may be designated to trade all the rights of a certain property, e.g. real, mineral, structural, etc. Alternatively, it may be designated to trade a certain type of right, e.g. mineral rights, for a multitude of properties. There may also be separate trading areas for bifurcated land and slice of a whole TIC interests.

Trading takes place in an open-outcry type of auction such as would be found on the floor of the NYSE. A special trader, known as a specialist broker 720, acts as a facilitator and auctioneer between buyers 740 and sellers 730. The buyers 740, sellers 730, and specialist broker 720 use hand signals and yell commands as the auction progresses to indicate buy or sell commands, or to make their bids known to the group. This open outcry system allows for efficient price discovery on the trading floor. Transactions may be completed, once there is a meeting of the minds, using traditional paper “chits” between buyer and seller. In another embodiment, traders may be equipped with handheld electronic devices to record the transactions.

In yet another embodiment, the secondary market in bifurcated land and slice of a whole tenant in common real property interests is created as both an electronic market and a physical market in a specified location. The information created by both the CTTS and the public outcry auction is combined to provide buyers and traders using both methods almost instantaneous market information. This embodiment allows for both the efficient price discovery of a trading floor and the high volume afforded by an electronic exchange.

In still another embodiment of the present invention, unimproved land and surface and sub-surface mineral rights are legally bifurcated from the improvements on the land. In this manner, BaLTIC interests can be sold as a pure land investment. As a result, the SEC should not classify these interests as a security. This reduces the amount of paperwork and oversight involved for both the promoter and the investor. Additionally, IRC §1031 allows the exchange of like-kind property tax fee. Moreover, under Internal Revenue Procedure 2002-22, TICs with less than 35 members will not be taxed at the partnership level, thus preventing double taxation to interest owners. Finally, BaLTIC real estate investments, because they contain no business interest, should not be limited by the 35 investor rule in Rev. Proc. 2002-22.

The present invention provides a variety of methods for creating an efficient and successful secondary market in tenant in common real property interests. By creating a centralized system, the present invention de-fractionalizes the secondary market in tenant in common real property interests. The present invention also provides a secure and reliable method for buying and selling tenant in common real property interests. The methods may include a traditional brick and mortar type of physical exchange or a purely electronic exchange over an electronic data network. The present invention may also advantageously incorporate elements of both methods to provide a close to ideal secondary market.

While specific embodiments of the present invention have been described, other and further modifications and changes may be made without departing from the spirit of the invention. All further and other modifications and changes are included that come within the scope of the invention as set forth in the claims. The disclosures of all publications cited above are expressly incorporated by reference in their entireties to the same extent as if each were incorporated by reference individually.

What is claimed is:

1. A system comprising an exchange for tenant in common real property ownership interests.

2. The system of claim 1, wherein said tenant in common real property ownership interests comprise fractional ownership in a slice of a whole tenant in common property.

3. The system of claim 1, wherein said tenant in common real property ownership interests comprise fractional ownership in a bifurcated land tenant in common property.

4. The system of claim 2, wherein a slice of a whole tenant in common property comprises one or more selected from the group consisting of vacant land, surface natural resource rights, subsurface natural resource rights, and land improvement assets.

5. The system of claim 3, wherein a bifurcated land tenant in common property comprises vacant land, surface natural resource rights, and subsurface natural resource rights that have been legally bifurcated from all land improvement assets.

6. The system of claim 4, wherein said surface natural resources rights comprise one or more selected from the group consisting of water rights, mineral rights, and timber rights.

7. The system of claim 4, wherein said subsurface resources rights comprise one or more selected from the group consisting of water rights, mineral rights, and fossil fuel rights.

8. The system of claim 4, wherein said land improvement assets comprise one or more selected from the group consisting of structures built upon said land, agricultural assets, and recreational assets.

9. The system of claim 8, wherein said structures comprise one or more from the group consisting of single-family homes, high-density housing, office buildings, retail stores, factories, mills, foundries, mines, and oil drilling facilities.

10. The system of claim 8, wherein said agricultural assets comprise one or more from the group consisting of farms, ranches, slaughterhouses, and aquaculture facilities.

11. The system of claim 8, wherein said recreational assets comprise one or more from the group consisting of golf courses, tennis courts, amusement parks, private clubs, resorts, ski resorts, camps, hunting areas, race tracks and casinos.

12. The system of claim 5, wherein said surface natural resources rights comprise one or more selected from the group consisting of water rights, mineral rights, and timber rights.

13. The system of claim 5, wherein said subsurface resources rights comprise one or more selected from the group consisting of water rights, mineral rights, and fossil fuel rights.

14. The system of claim 5, wherein said land improvement assets comprise one or more selected from the group consisting of structures built upon said land, agricultural assets, and recreational assets.

15. The system of claim 14, wherein said structures comprise one or more from the group consisting of single-family homes, high-density housing, office buildings, retail stores, factories, mills, foundries, mines, and oil drilling facilities.

16. The system of claim 14, wherein said agricultural assets comprise one or more from the group consisting of farms, ranches, slaughterhouses, and aquaculture facilities.

17. The system of claim 14, wherein said recreational assets comprise one or more from the group consisting of golf courses, tennis courts, amusement parks, private clubs, resorts, ski resorts, camps, hunting areas, race tracks and casinos.

18. The system of claim 1, wherein said exchange comprises a physical exchange in a specified location.

19. The system of claim 1, wherein said exchange comprises an electronic exchange that exists on an electronic data network.

20. The system of claim 1, wherein said exchange utilizes one or more physical exchanges in one or more physical locations and one or more electronic exchanges that exist over an electronic data network.

21. A method comprising the steps of:
receiving a request to sell a tenant in common real property interest from a seller;
providing said sale price to one or more users;
receiving one or more bids for said tenant in common real property ownership interests from one or more buyers;
providing said bid prices to one or more users; and
deciding whether to accept one or more bids from said one or more buyers.

22. The method of claim 21, wherein said deciding step comprises:
querying a database comprising bids from one or more buyers;
approving all bids that are higher than said price requested in said sell request and that do not exceed the number of interests available in said sell request; and
denying all bids that are below said price requested in said sell request or that exceed the number of interests available in said sell request.

23. The method of claim 21, wherein said sell request comprises one or more selected from the group consisting of the seller, the price, number of interests available, and location of the property.

24. The method of claim 21, wherein said tenant in common real property ownership interests comprise fractional ownership in a slice of a whole tenant in common property.

25. The method of claim 21, wherein said tenant in common real property ownership interests comprise fractional ownership in a bifurcated land tenant in common property.

26. The method of claim 24, wherein said slice of a whole tenant in common property comprises one or more selected from the group consisting of vacant land, surface natural resource rights, subsurface natural resource rights, and land improvement assets.

27. The method of claim 25, wherein a bifurcated land tenant in common property comprises vacant land, surface natural resource rights, and subsurface natural resource rights that have been legally bifurcated from all land improvement assets.

28. The method of claim 26, wherein said surface natural resources rights comprise one or more selected from the group consisting of water rights, mineral rights, and timber rights.

29. The method of claim 26, wherein said subsurface resources rights comprise one or more selected from the group consisting of water rights, mineral rights, and fossil fuel rights.

30. The method of claim 26, wherein said land improvement assets comprise one or more selected from the group consisting of structures built upon said land, agricultural assets, and recreational assets.

31. The method of claim 30, wherein said structures comprise one or more from the group consisting of single-family homes, high-density housing, office buildings, retail stores, factories, mills, foundries, mines, and oil drilling facilities.

32. The method of claim 30, wherein said agricultural assets comprise one or more from the group consisting of farms, ranches, slaughterhouses, and aquaculture facilities.

33. The method of claim 30, wherein said recreational assets comprise one or more from the group consisting of golf courses, tennis courts, amusement parks, private clubs, resorts, ski resorts, camps, hunting areas, race tracks and casinos.

34. The method of claim 27, wherein said surface natural resources rights comprise one or more selected from the group consisting of water rights, mineral rights, and timber rights.

35. The method of claim 27, wherein said subsurface resources rights comprise one or more selected from the group consisting of water rights, mineral rights, and fossil fuel rights.

36. The method of claim 27, wherein said land improvement assets comprise one or more selected from the group consisting of structures built upon said land, agricultural assets, and recreational assets.

37. The method of claim 36, wherein said structures comprise one or more from the group consisting of single-family homes, high-density housing, office buildings, retail stores, factories, mills, foundries, mines, and oil drilling facilities.

38. The method of claim 36, wherein said agricultural assets comprise one or more from the group consisting of farms, ranches, slaughterhouses, and aquaculture facilities.

39. The method of claim 36, wherein said recreational assets comprise one or more from the group consisting of golf courses, tennis courts, amusement parks, private clubs, resorts, ski resorts, camps, hunting areas, race tracks and casinos.

40. The method of claim 21, wherein said sell request is received by an auctioneer in an open outcry type of auction.

41. The method of claim 21, wherein said sell request is received and stored by a program stored on one or more computers.

42. The method of claim 25, wherein said one or more computers are linked via an electronic data network.

43. The method of claim 26, wherein said electronic data network comprises one or more selected from the group consisting of the internet, an intranet, a token ring network, a wireless network, or a blue tooth network.

44. The method of claim 21, wherein said sale price is provided to one or more users in an open outcry type of auction.

45. The method of claim 21, wherein said sale price is provided to one or more users using a graphical user interface on one or more computers linked via an electronic data network.

46. The method of claim 29, wherein said electronic data network comprises one or more selected from the group consisting of the internet, an intranet, a token ring network, a wireless network, or a blue tooth network.

47. The method of claim 21, wherein said bids are received by an auctioneer in an open outcry type of auction.

48. The method of claim 21, wherein said bids are received and stored by a program on one or more computers.

49. The method of claim 48, wherein said one or more computers are linked via an electronic data network.

50. The method of claim 49, wherein said electronic data network comprises one or more selected from the group consisting of the internet, an intranet, a token ring network, a wireless network, or a blue tooth network.

51. The method of claim 21, wherein said bids are provided to one or more users via a graphical user interface on one or more computers linked via an electronic data network.

52. The method of claim 51, wherein said electronic data network comprises one or more selected from the group consisting of the internet, an intranet, a token ring network, a wireless network, or a blue tooth network.

53. The method of claim 21, wherein the buyer uses a qualified intermediary to facilitate the transaction.

54. A system comprising:
a memory device storing a program;
a processor in communication with said memory device;
said processor operable with said program to,
receive a request to sell a tenant in common real property interest from a seller;
provide said sale price to one or more users;
receive one or more bids for said tenant in common real property ownership interests from one or more buyers;
provide said bid prices to one or more users; and
decide whether to accept one or more bids from said one or more buyers.

55. The system of claim 54, wherein said processor is farther operable to:
query a database comprising bids from one or more buyers;
approve all bids that are higher than the price requested in said sell request and that do not exceed the number of interests available in said sell request: and
deny all bids that are below the price requested in said sell request or that exceed the number of interests available in said sell request.

56. The system of claim 54, wherein said processor is farther operable to provide a list of available sell requests and buy bids from one or more users.

57. The system of claim 56, wherein said list of sell requests and buy bids is provided via a graphical user interface on one or more computers linked via an electronic data network.

58. The system of claim 54, wherein said processor is further operable to update a list of available sell requests and buy bids in real time.

59. The system of claim 54, wherein said processor is further operable to remove a sell request from a list of available sell requests when the number of interests in said sell request reaches zero.

60. The system of claim 54, wherein said tenant in common real property ownership interests comprise fractional ownership in a slice of a whole tenant in common property.

61. The system of claim 54, wherein said tenant in common real property ownership interests comprise fractional ownership in a bifurcated land tenant in common property.

62. The system of claim 60, wherein said slice of a whole tenant in common property comprises one or more selected from the group consisting of vacant land, surface natural resource rights, subsurface natural resource rights, and land improvement assets.

63. The system of claim 61, wherein a bifurcated land tenant in common property comprises vacant land, surface natural resource rights, and subsurface natural resource rights that have been legally bifurcated from all land improvement assets.

64. The system of claim 62, wherein said surface natural resources rights comprise one or more selected from the group consisting of water rights, mineral rights, and timber rights.

65. The system of claim 62, wherein said subsurface resources rights comprise one or more selected from the group consisting of water rights, mineral rights, and fossil fuel rights.

66. The system of claim 62, wherein said land improvement assets comprise one or more selected from the group consisting of structures built upon said land, agricultural assets, and recreational assets.

67. The system of claim 66, wherein said structures comprise one or more from the group consisting of single-family homes, high-density housing, office buildings, retail stores, factories, mills, foundries, mines, and oil drilling facilities.

68. The system of claim 66, wherein said agricultural assets comprise one or more from the group consisting of farms, ranches, slaughterhouses, and aquaculture facilities.

69. The system of claim 66, wherein said recreational assets comprise one or more from the group consisting of golf courses, tennis courses, amusement parks, private clubs, resorts, ski resorts, camps, hunting areas, race tracks and casinos.

70. The system of claim 63, wherein said surface natural resources rights comprise one or more selected from the group consisting of water rights, mineral rights, and timber rights.

71. The system of claim 63, wherein said subsurface resources rights comprise one or more selected from the group consisting of water rights, mineral rights, and fossil fuel rights.

72. The system of claim 63, wherein said land improvement assets comprise one or more selected from the group consisting of structures built upon said land, agricultural assets, and recreational assets.

73. The system of claim 72, wherein said structures comprise one or more from the group consisting of single-family homes, high-density housing, office buildings, retail stores, factories, mills, foundries, mines, and oil drilling facilities.

74. The system of claim 72, wherein said agricultural assets comprise one or more from the group consisting of farms, ranches, slaughterhouses, and aquaculture facilities.

75. The system of claim 72, wherein said recreational assets comprise one or more from the group consisting of golf courses, tennis courts, amusement parks, private clubs, resorts, ski resorts, camps, hunting areas, race tracks and casinos.

76. The method of claim 54, wherein the buyer uses a qualified intermediary to facilitate the transaction.

77. An article of manufacture comprising:
a computer readable storage medium comprising instructions, said instructions comprising instructions for:
receiving a request to sell a tenant in common real property interest from a seller;
providing said sale price to one or more users;
receiving one or more bids for said tenant in common real property ownership interests from one or more buyers;
providing said bid prices to one or more users; and
deciding whether to accept one or more bids from said one or more buyers.

78. The article of manufacture of claim 77, wherein said processor is further operable to:
querying a database comprising bids from one or more buyers;
approving all bids that are higher than the price requested in said sell request and that do not exceed the number of interests available in said sell request; and
denying all bids that are below the price requested in said sell request or that exceed the number of interests available in said sell request.

79. The article of manufacture of claim 77, wherein said processor is further operable to provide a list of available sell requests and buy bids from one or more users.

80. The article of manufacture of claim 77, wherein said list of sell requests and buy bids is provided via a graphical user interface on one or more computers linked via an electronic data network.

81. The article of manufacture of claim 77, wherein said processor is further operable to update a list of available sell requests and buy bids in real time.

82. The article of manufacture of claim 77, wherein said processor is further operable to remove a sell request from a list of available sell requests when the number of interests in said sell request reaches zero.

83. The article of manufacture of claim 77, wherein said tenant in common real property ownership interests comprise fractional ownership in a slice of a whole tenant in common property.

84. The article of manufacture of claim 77, wherein said tenant in common real property ownership interests comprise fractional ownership in a bifurcated land tenant in common property.

85. The article of manufacture of claim 83, wherein said slice of a whole tenant in common property comprises one or more selected from the group consisting of vacant land, surface natural resource rights, subsurface natural resource rights, and land improvement assets.

86. The article of manufacture of claim 84, wherein a bifurcated land tenant in common property comprises vacant land, surface natural resource rights, and subsurface natural resource rights that have been legally bifurcated from all land improvement assets.

87. The article of manufacture of claim 85, wherein said surface natural resources rights comprise one or more selected from the group consisting of water rights, mineral rights, and timber rights.

88. The article of manufacture of claim 85, wherein said subsurface resources rights comprise one or more selected from the group consisting of water rights, mineral rights, and fossil fuel rights.

89. The article of manufacture of claim 85, wherein said land improvement assets comprise one or more selected from the group consisting of structures built upon said land, agricultural assets, and recreational assets.

90. The article of manufacture of claim 89, wherein said structures comprise one or more from the group consisting of single-family homes, high-density housing, office buildings, retail stores, factories, mills, foundries, mines, and oil drilling facilities.

91. The article of manufacture of claim 89, wherein said agricultural assets comprise one or more from the group consisting of farms, ranches, slaughterhouses, and aquaculture facilities.

92. The article of manufacture of claim 89, wherein said recreational assets comprise one or more from the group consisting of golf courses, tennis courts, amusement parks, private clubs, resorts, ski resorts, camps, hunting areas, race tracks and casinos.

93. The article of manufacture of claim 86, wherein said surface natural resources rights comprise one or more selected from the group consisting of water rights, mineral rights, and timber rights.

94. The article of manufacture of claim 86, wherein said subsurface resources rights comprise one or more selected from the group consisting of water rights, mineral rights, and fossil fuel rights.

95. The article of manufacture of claim 86, wherein said land improvement assets comprise one or more selected from the group consisting of structures built upon said land, agricultural assets, and recreational assets.

96. The article of manufacture of claim 95, wherein said structures comprise one or more from the group consisting of single-family homes, high-density housing, office buildings, retail stores, factories, mills, foundries, mines, and oil drilling facilities.

97. The article of manufacture of claim 95, wherein said agricultural assets comprise one or more from the group consisting of farms, ranches, slaughterhouses, and aquaculture facilities.

98. The article of manufacture of claim 95, wherein said recreational assets comprise one or more from the group consisting of golf courses, tennis courts, amusement parks, private clubs, resorts, ski resorts, camps, hunting areas, race tracks and casinos.

99. The article of manufacture of claim 77, wherein the seller uses a qualified intermediary to facilitate the transaction.
